(19) United States
(12) Patent Application Publication
(10) Pub. No.: US 2023/0228222 A1
(43) Pub. Date: Jul. 20, 2023

(54) Engine, an Aircraft, and a Throttle Thereof

(71) Applicant: Autoflight (Kunshan) Co., Ltd., Kunshan City (CN)

(72) Inventor: Yu Tian, Hong Kong SAR (CN)

(21) Appl. No.: 18/154,813

(22) Filed: Jan. 14, 2023

(30) Foreign Application Priority Data
Jan. 14, 2022 (CN) 202220093775.8

(51) Int. Cl. F02D 9/10

(52) U.S. Cl. CPC F02D 9/1065; F02D 9/105

(57) ABSTRACT

An aircraft having an engine and a throttle thereof. The throttle has a throttle body (1), the throttle body (1) is provided with a cavity (10) and comprises an inlet port (11) and an outlet port (12) both of which are connected to the cavity (10); a plurality of fuel injectors (2), each of the fuel injectors (2) is arranged on the throttle body (1) and can spray fuel into the cavity (10) of the throttle body (1); and an air filter (3). The air filter (3) is arranged on the throttle body (1) and connected to the inlet port (11). There is an air door (4) that can rotate in the cavity (10) to connect or block the inlet port (11) and the outlet port (12). Additionally, there is an air door driving part connected to the air door (4) and controls the rotation of the air door (4).

### CROSS-REFERENCES

This application claims priority to China Patent Application No. 202220093775.8, filed on Jan. 14, 2022, which is hereby incorporated by reference in its entirety.

Although incorporated by reference in its entirety, no arguments or disclaimers made in the parent application apply to this divisional application. Any disclaimer that may have occurred during the prosecution of the above-referenced application(s) is hereby expressly rescinded.

### FIELD OF THE DISCLOSURE

The invention relates to the technical field of aircraft, in particular to an engine, an aircraft and a throttle thereof.

### BACKGROUND OF THE INVENTION

Existing two-cylinder two-stroke piston type aeroengine usually designs a fuel injector to supply fuel, but in this case, once the fuel injector is blocked and causes insufficient fuel supply or cannot supply fuel at all, it will immediately cause the engine to stop running. In this case, there is no redundant design for important components. If the engine fails during flight, there is no emergency response plan, which is very dangerous.

### SUMMARY OF THE INVENTION

The purpose of the invention is to provide an engine, an aircraft and a throttle thereof. The throttle of the invention can improve engine reliability.

For this purpose, the first aspect of the disclosure provides a throttle, which can comprise: a throttle body, the throttle body can be provided with a cavity and can comprise an inlet port and an outlet port both of which are connected to the cavity. There can be a plurality of fuel injectors, each of which is arranged on the throttle body and can spray fuel into the cavity of the throttle body. There can be an air filter arranged on the throttle body and can be connected to the inlet port. There can be an air door rotatably disposed in the cavity to open or block the inlet port and the outlet port. There can be an air door driving part connected to the air door to control the rotation of the air door.

The second aspect of the disclosure provides an engine, which can include the described throttle above.

The third aspect of the disclosure provides an aircraft, which can include the described engine above.

Moreover, in one embodiment of the disclosed subject matter, the number of the fuel injectors is two, or at least two.

Moreover, each fuel injector can be arranged on the side wall of the throttle body between the air door and the outlet port and can be connected to the cavity.

Moreover, the fuel injection port of each fuel injector can be arranged obliquely toward the outlet port.

Moreover, the air door driving part can be a steering gear, and the output shaft of the steering gear can be coaxially connected to the air door rotation shaft of the air door.

Moreover, the throttle can further comprise a position sensor, and the position sensor can be connected to the air door and used to detect the opening angle of the air door.

Moreover, the throttle can further comprise a pressure sensor. The pressure sensor can be connected to the throttle body and can be used to detect the intake air pressure.

Moreover, each of the fuel injectors can be provided with a quick-connection part, and the quick-connection part can be used to connect to the fuel delivery pipe.

Compared with the prior art, one contemplated implementation mode of the disclosure with double fuel injectors ensures that the one fuel injector can work when the other fuel injectors is blocked or fails, thereby improving the reliability of the engine.

### BRIEF DESCRIPTION OF DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 shows the structure diagram of the throttle provided by an embodiment of the present invention.

FIG. 2 shows a cross-sectional view of the throttle in FIG. 1.

The following call-out list of elements in the drawing can be a useful guide when referencing the elements of the drawing figures:

1 throttle body; 10 cavity; 11 inlet port; 12 outlet port;

2 fuel injector; 2a fuel injector A; 2b fuel injector B; 21 quick-connection part;

3 air filter;

4 air door; 41 air door rotation shaft;

5 air door rotating assembly; 51 rotating part; 52 spring; 53 fixed bracket;

6 pressure sensor;

7 position sensor;

8 limiting part.

### DETAILED DESCRIPTION

The following describes the various possible implementation modes of the disclosed subject matter through specific embodiments, and those skilled in the art can easily understand the advantages and effects of the embodiments from the contents disclosed in the description. The contemplated subject matter can also be implemented or applied by different embodiments, and various details in the specification can also be modified or changed based on different views and application systems without departing from the purpose of the disclosed subject matter. It should be noted that the various features in the embodiments in the invention can be combined with each other.

The following is a detailed description of the embodiments of the invention with reference to the drawings. The invention can be embodied in a variety of different forms, and is not limited to the embodiments described herein.

In order to clearly explain the invention, devices irrelevant to the description are omitted, and the same reference symbols are assigned to the same or similar constituent elements in the entire specification.

In the entire specification, when a part is described to be “connected” with another part, it includes not only the case of “direct connection”, but also the case of “indirect connection” where other components are placed between them. In addition, when a device “includes” certain constituent elements, as long as there is no record to the contrary, it does not exclude other constituent elements, it means that it can also include other constituent elements.

When a device is described to be “above” another part, it can be directly on the other part, but it can also be accompanied by other parts in between. In contrast, when a part is described as being “directly” on another part, it is not accompanied by other devices in between.

Although the terms “first”, “second”, and such words are used herein to describe various elements in some examples, these elements should not be limited by these terms. These terms are used only to distinguish one element from another. For example, the first interface and the second interface etc. Furthermore, as used herein, the singular forms “one,” “a” and “the” are intended to include the plural, unless the context indicates otherwise. It should be further understood that the terms “comprise” and “include” indicate the existence of the described features, steps, operations, elements, components, items, categories, and/or groups, but do not exclude the existence, presence, or addition of one or more other features, steps, operations, elements, components, items, categories, and/or groups. The terms “or” and “and/or” as used herein are interpreted to be inclusive or to mean any one or any combination thereof. Therefore, “A, B or C” or “A, B and/or C” means “any of the following: A; B; C; A and B; A and C; B and C; A, B and C.” Exceptions to this definition occur only when combinations of components, functions, steps, or operations are inherently mutually exclusive in some ways.

The technical terms used herein are only used to refer to specific embodiments and are not intended to limit the invention. The singular form used here also includes the plural form, as long as the statement does not clearly express the opposite meaning. The meaning of “including” used in the specification is to specify the unique characteristics, regions, integers, steps, operations, elements and/or components, not to exclude the existence or addition of other characteristics, regions, integers, steps, operations, elements and/or components.

The terms “under,” “over” and other relative spaces term may be used in order to illustrate more easily the direction relationship of one device to another illustrated in the drawings. The terms are, not only in the sense referred to in the drawings, but also in other senses or operations of the device in use. For example, if the device in the drawings is turned over, a device that was illustrated as being “under” another device is illustrated as being “over” another device. Thus, the exemplary term “under” includes both above and below. Devices can be rotated by 90° or other angles and the terms representing relative space are interpreted accordingly.

Although it is not defined differently, all terms, including technical terms and scientific terms used herein, have the same meaning as is generally understood by those skilled in the art to which the present invention belongs. Terms defined in commonly used dictionaries are additionally interpreted as having a meaning consistent with the content of the relevant technical literature and current understandings, and can't be over-interpreted in a desirable or very formulaic sense, provided that they are not defined.

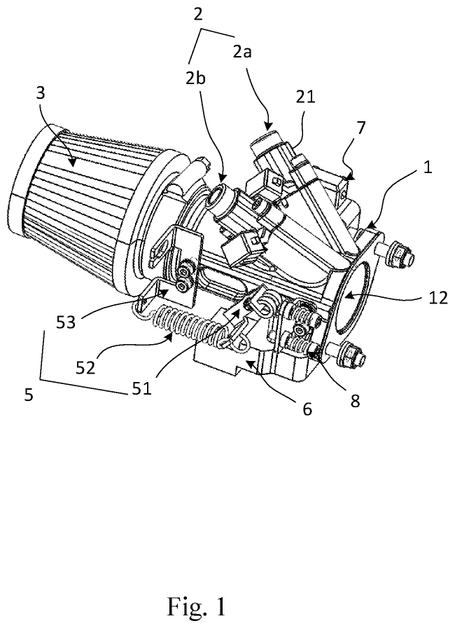

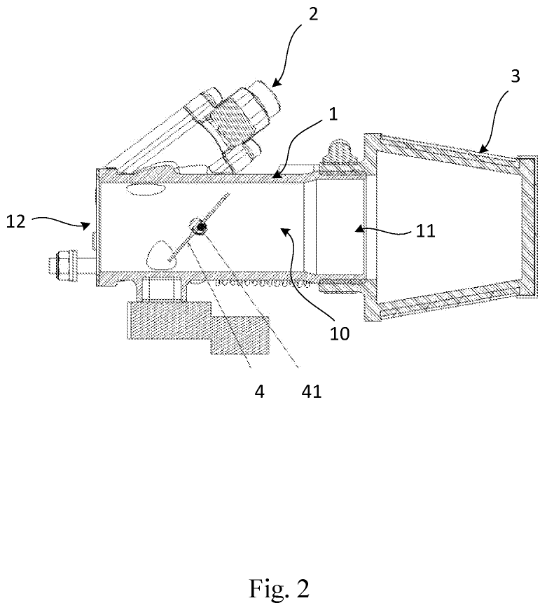

The first embodiment of the invention is described below with reference to the drawings. As shown in FIGS. 1 and 2, the throttle of the invention comprises a throttle body 1, a fuel injector 2, an air filter 3, an air door 4 and an air door driving part (not shown in the figure), the throttle body 1 is provided with a cavity 10, and the cavity 10 has an inlet port 11 and an outlet port 12. The fuel injectors 2 is arranged on the throttle body 1 and connected to the cavity 10, and it can spray oil into the cavity 10. The cross section of the cavity 10 is preferably circular, but it can also be other shapes, it is not limited here. The fuel injector 2 is preferably arranged on the side wall of the throttle body 1 between the air door 4 and the outlet port 12 and connected to the cavity 10, and the fuel injection port of the fuel injector 2 which connected to the cavity 10 is arranged preferably obliquely toward the outlet port 12. The fuel injector 2 comprises fuel injector a and fuel injector b. Through the implementation of double fuel injectors, one fuel injector can work when the other fuel injector is blocked or fails. However, it is understandable that it can also be provided with more than two fuel injectors. The fuel injector is provided with a quick connection part 21, which is used to connect to the fuel delivery pipe, making such connection convenient and quick.

The air filter 3 can be arranged on the throttle body 1 and can be connected to the inlet port 11. The outside air is filtered through the air filter 3 to prevent impurities from entering the engine and damaging the engine. The air door 4 is arranged in the cavity 10, which can rotate in the cavity 10 to connect or block the inlet port 11 and the outlet port 12, thereby controlling the volume of air intake. The fuel sprayed out by the injector 2 is mixed with the air passing through the air door 4 and then enters the engine. The amount of fuel and air can be controlled through the fuel injector 2 and the air door 4 respectively, so as to obtain the corresponding mixing ratio to supply the engine to work. The rotation of the air door 4 can be realized by the air door driving part. The air door driving part can be a steering gear. The output shaft of the steering gear can be coaxially connected to the rotation shaft of the air door 4, and the rotation of the air door is controlled by the steering gear.

In some embodiments, the air door driving part is connected to the air door 4 through a pull wire (not shown in the figure) to control the rotation of the air door 4. The air door driving part can be installed separately from the engine through the pull wire, so as to avoid the influence of engine vibration, thereby greatly reducing the probability of failure and increasing the working life. The air door driving part can be a steering gear. The steering gear is installed separately from the throttle, and the volume of air intake is controlled by pulling the air door with the pull wire, which avoids the engine vibration being too strong to damage the steering gear, causing the engine to run out of control, and improves the reliability of the engine.

In some embodiments, as shown in FIG. 1 , the throttle further comprises an air door rotating assembly 5, the air door rotating assembly 5 comprises a rotating part 51 and a spring 52, and the middle part of the rotating part 51 is fixedly connected to the air door rotating shaft 41 of the air door 4, the first end of the spring 52 is connected to the first end of the rotating part 51, the second end of the spring 52 is connected to the throttle body 1, the second end of the rotating part 51 is connected to the first end of the pull wire, and the second end of the pull wire is connected to the steering gear. Further, the pull wire can pass through the fixed bracket 53 in FIG. 1 to connect to the steering gear, the spring 52 is connected to the throttle body 1 through the fixed bracket 53, and the fixed bracket 53 can be placed horizontally with the rotating part 51 to form a horizontal pull, to achieve better pull efficiency. Of course, the pull wire can also be connected without passing through the fixing bracket 53, which is not limited here. When the steering gear pulls the pull wire, the second end of the rotating part 51 is pulled towards the fixed bracket 53, thereby driving the rotation of the air door rotating shaft 41 of the air door 4 to realize the rotation of the air door 4, while the spring 52 is elongated. When the air door 4 needs to rotate in the opposite direction, it is only necessary to reversely drive the steering gear. At this time, the pull wire is loosened, and the second end of the rotating part 51 is pulled away from the fixed bracket 53 due to the elastic force of the spring 52, thereby realizing the reverse rotation of the air door 4.

In some embodiments, the embodiment of the present invention further comprises a pressure sensor 6, which is connected to the throttle body 1 and used to detect the intake air pressure. In some embodiments, the embodiment of the present application further comprises a position sensor 7, which can be connected to the air door rotation shaft 41 of the air door 4 and used to detect the air door opening angle of the air door 4.

The throttle can also comprise a limiting part 8, which can be set to move left and right in the horizontal direction, because it is close to the rotating part 51, thereby limiting the movement of the rotating part 51.

The second embodiment of the present application provides an engine, including the throttle mentioned above. The throttle of the engine in this embodiment is provided with double fuel injectors to ensure that the other fuel injector can work instead when one of the fuel injectors is blocked or fails, thereby improving the reliability of the engine.

The third embodiment of the present application provides an aircraft, including the above-mentioned engine. In this embodiment, the throttle of the aircraft engine is provided with double fuel injectors to ensure that the other fuel injector work instead when one of the fuel injectors is blocked or fails, thereby improving the reliability of the engine.

The above embodiments are merely illustrative of the principles of the present invention and its effects; these embodiments are not intended to limit the invention. Any person skilled in the art can modify or alter the above embodiments without departing from the purpose and the scope of the present invention. Accordingly, all equivalent modifications or alterations made by persons having ordinary knowledge in the art, without departing from the purpose and technical ideas disclosed in the present invention, shall still be covered by the claims of the present invention.

1. A throttle for an engine, the throttle comprising:
a throttle body (1) provided with a cavity (10), an inlet port (11), and an outlet port (12), wherein the inlet port and the outlet port are connected to the cavity (10);
a plurality of fuel injectors (2), wherein each of the fuel injectors (2) is arranged on the throttle body (1) and sprays fuel into the cavity (10) of the throttle body (1);
an air filter (3) arranged on the throttle body (1) and is connected to the inlet port (11);
an air door (4) rotatably disposed in the cavity (10) to open or block the inlet port (11) and the outlet port (12); and
an air door driving part connected to the air door (4) to control a rotation of the air door (4).

2. The throttle according to claim 1, wherein the plurality of fuel injectors (2) includes two fuel injectors.

3. The throttle according to claim 1, wherein each of said plurality of fuel injectors (2) is arranged on a side wall of the throttle body (1) between the air door (4) and the outlet port (12), wherein each of said plurality of fuel injectors is connected to the cavity (10).

4. The throttle according to claim 3 further comprising a fuel injection port for each of said plurality of fuel injectors (2) and said each fuel injection port is arranged obliquely towards the outlet port (12).

5. The throttle according to claim 1, wherein the air door driving part is a steering gear, and an output shaft of the steering gear is coaxially connected to an air door rotation shaft (41) of the air door (4).

6. The throttle according to claim 1 further comprising a position sensor (7), the position sensor (7) is connected to the air door (4) and used to detect the opening angle of the air door (4).

7. The throttle according to claim 5 further comprising a pressure sensor (6) connected to the throttle body (1) and to detect an intake air pressure.

8. The throttle according to claim 1, wherein each of the plurality of fuel injectors (2) is provided with a quick-connection part (21) to connect to a fuel delivery pipe.

9. An engine, which is characterized in that it includes the throttle described in claim 1.

10. An engine, which is characterized in that it includes the throttle described in claim 2.

11. An engine, which is characterized in that it includes the throttle described in claim 3.

12. An engine, which is characterized in that it includes the throttle described in claim 4.

13. An engine, which is characterized in that it includes the throttle described in claim 5.

14. An engine, which is characterized in that it includes the throttle described in claim 6.

15. An engine, which is characterized in that it includes the throttle described in claim 7.

16. An engine, which is characterized in that it includes the throttle described in claim 8.

17. An aircraft, which is characterized in that it includes the engine described in claim 1.
